(19) United States
(12) Patent Application Publication
(10) Pub. No.: US 2026/0113575 A1
(43) Pub. Date: Apr. 23, 2026

(54) METHOD FOR INSTALLING AND CONTROLLING LIGHT-SOUND CINEMA SPEAKER TO PROVIDE LIGHT-SOUND SYSTEM TO MOVIE THEATER AND DEVICE THEREFOR

(71) Applicant: LOTTE CULTUREWORKS CO., LTD., Seoul (KR)

(72) Inventors: Seokbong WOO, Busan (KR); Myeonggyu SEONG, Incheon (KR); Yongsub YOON, Seoul (KR); Chuloh YOON, Namyangju-si (KR); Soomin LEE, Seoul (KR); Kiwon SEO, Seoul (KR); Youngkyu YOU, Seoul (KR)

(73) Assignee: LOTTE CULTUREWORKS CO., LTD., Seoul (KR)

(21) Appl. No.: 19/365,039

(22) Filed: Oct. 21, 2025

(30) Foreign Application Priority Data
Oct. 23, 2024 (KR) 10-2024-0145447

(51) Int. Cl. H04R 5/02; H04R 1/02; H04R 1/28; H04R 3/12; H05B 47/165

(52) U.S. Cl. CPC H04R 5/02; H04R 1/028; H04R 1/2896; H04R 3/12; H05B 47/165; H04R 2205/024; H04R 2205/026; H04R 2430/03

(57) ABSTRACT

The present disclosure relates to a method for installing and controlling light-sound cinema speakers to provide a light-sound system in a movie theater, which is performed by a light-sound system control device, the method including loading data from a speaker installation terminal; loading information on the movie theater; setting speaker installation positions for a light-sound system based on the loaded data and information; operating and performing the light-sound system; and calculating optimal information for the light-sound system based on the operation of the light-sound system.

### CROSS-REFERENCE TO RELATED APPLICATION

This application claims the benefit of and priority to Korean Patent Application No. 10-2024-0145447, filed on Oct. 23, 2024, the entire disclosure(s) of which is hereby incorporated herein by reference in its entirety.

### TECHNICAL FIELD

The present disclosure relates to a method for installing and controlling a light-sound cinema speaker for providing a light-sound system to a movie theater, and a device therefor, and more specifically, to a method capable of providing a light-sound system more effectively by setting various speaker positions and utilizing data doubling, a subwoofer, and the like, and a device therefor.

### BACKGROUND

Sound effects (SE) are a term used to refer to sounds in a frequency band of sounds other than a general frequency band of sounds, such as dialogue, music, and narration, or to intentionally added sounds. The sound effects are also used in televisions, radios, films, and stages. On-screen sounds and off-screen sounds are effectively used to enhance not only actors' dialogue but also dramatic effects, and the sounds include both realistic sounds and unrealistic sounds, but are distinct from so-called music. The sound effects are also an important element in commercial films.

Consequently, the film industry is increasingly utilizing such sound effects, and a growing number of movie theaters are enhancing or emphasizing the sound effects. In the film market, a method for effectively providing sound effects that consumers may perceive in a film beyond the visual quality and content of the film itself will need to be specifically discussed.

A method for more effectively providing sound effects to consumers in a film industry or market will be described herein.

The above-described background technology is technical information possessed for derivation of the present disclosure by the inventors or acquired during derivation of the present disclosure, and is not necessarily a technology known to the public prior to the filing of the present disclosure.

### SUMMARY

An object of the present disclosure is to provide sound that satisfies customers' needs based on the capabilities of engineers beyond the regulations and restrictions of standard acoustic criteria for a theater for quality improvement.

Another object of the present disclosure is to provide acoustic effects of a movie theater more effectively by utilizing speaker installation positions within the movie theater, a doubling method, and the like.

The present disclosure provides a method performed by a light-sound system control device, the method including: loading data from a speaker installation terminal; loading information on the movie theater; setting speaker installation positions for a light-sound system based on the loaded data and information; operating and performing the light-sound system; and calculating optimal information for the light-sound system based on the operation of the light-sound system.

In an aspect, the setting of the speaker installation positions for a light-sound system based on the loaded data and information may further include setting a subwoofer position to the front of the movie theater.

In an aspect, the setting of the speaker installation positions for a light-sound system based on the loaded data and information may further include setting installation of a vibration isolation device under at least one speaker.

In an aspect, the operating and performing of the light-sound system may further include additionally extracting Low from a front channel for data doubling when the light-sound system operates.

In an aspect, the operating and performing of the light-sound system may further include allocating Left Low to a subwoofer at a left end, which is one of both ends, among subwoofers arranged to be exposed at the front, and assigning Right Low to a subwoofer at a right end, which is the other end.

In an aspect, the operating and performing of the light-sound system may further include adding a subwoofer only for a surround channel to reinforce a low frequency range, and operating the light-sound system.

According to the present disclosure, it is possible to provide sound that satisfies customers' needs based on the capabilities of engineers beyond the regulations and restrictions of standard acoustic criteria for a theater for quality improvement.

According to the present disclosure, it is also possible to provide acoustic effects of a movie theater more effectively by utilizing speaker installation positions within the movie theater, a doubling method, and the like.

### BRIEF DESCRIPTION OF THE DRAWINGS

FIG. 1 illustrates an exemplary environment in which a light-sound system control device may be applied according to some embodiments of the present disclosure.

FIG. 2 is a flowchart illustrating a light-sound system control operation that may be performed by the light-sound system control device according to some embodiments of the present disclosure.

FIG. 3 is a flowchart for specifically describing a step of setting speaker installation positions for the light-sound system according to some embodiments of the present disclosure.

FIG. 4 is a flowchart for specifically describing a step of operating and performing the light-sound system according to some embodiments of the present disclosure.

FIG. 5 is a diagram illustrating an exemplary computing device that can implement devices and/or systems according to various embodiments of the present disclosure.

### DETAILED DESCRIPTION

Hereinafter, preferred embodiments of the present disclosure will be described in detail with reference to the accompanying drawings. The advantages and features of the present disclosure and methods for achieving these will become apparent with reference to the embodiments to be described in detail below, together with the accompanying drawings. However, the technical spirit of the present disclosure is not limited to the following embodiments and may be implemented in various different forms, the following embodiments are provided solely to complete the technical spirit of the present disclosure and to fully inform those skilled in the art of the scope of the present disclosure, and the technical spirit of the present disclosure is defined solely by the claims.

When components in drawings are denoted by reference numerals, it should be noted that the same components are denoted by the same reference numerals whenever possible, even when the components appear in different drawings. Further, when the present disclosure is described, detailed descriptions of related well-known configurations or functions will be omitted when the descriptions are deemed to obscure the gist of the present disclosure.

Unless otherwise defined, all terms (including technical and scientific terms) used herein may be used in a sense commonly understood by those skilled in the art of the present disclosure. Further, terms defined in commonly used dictionaries should not be construed ideally or excessively unless explicitly defined otherwise. The terms used herein are for the purpose of describing embodiments and are not intended to limit the present disclosure. In the present disclosure, the singular form also includes the plural form unless otherwise stated in the context.

Further, terms such as first, second, A, B, (a), and (b) may be used in describing components of the present disclosure. These terms are merely intended to distinguish the components from other components and do not limit the nature, order, sequence, or the like of the components. When a component is described as being “connected” or “coupled,” to another component, it should be understood that the component may be directly connected or coupled to the other component, but another component may also be “connected” or “coupled” between the components.

The terms “comprise” and/or “comprising” as used herein do not exclude the presence or addition of one or more other components, steps, operations, and/or elements.

Hereinafter, various embodiments of the present disclosure will be described in detail with reference to the accompanying drawings.

Further, terms such as first, second, A, B, (a), and (b) may be used in describing components of the present disclosure. These terms are merely intended to distinguish the components from other components and do not limit the nature, order, sequence, or the like of the components. Throughout the disclosure, when a certain part is referred to as “including” or “comprising” a certain component, this does not exclude other components, but rather implies the inclusion of other components, unless specifically stated otherwise. Further, terms such as “unit” and “module” described in the disclosure refer to a unit that processes at least one function or operation, which may be implemented using hardware, software, or a combination of hardware and software.

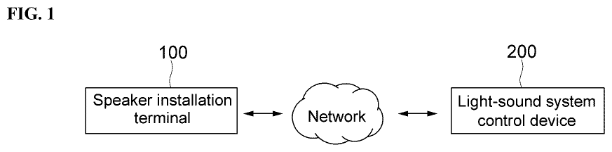

FIG. 1 illustrates an exemplary environment in which light-sound system control devices according to some embodiments of the present disclosure may be applied. Through a system including a speaker installation terminal 100 and a light-sound system control device 200 illustrated in FIG. 1, an operation of providing a “light-sound cinema system” in which at least one speaker is installed in a movie theater to provide sound effects that satisfy customers' needs to movie theater customers may be performed.

Hereinafter, the components illustrated in FIG. 1 related to an operation of providing light-sound cinema sound effects using the speaker installation terminal 100 and the light-sound system control device 200 through the above-described system will be described in greater detail.

While FIG. 1 illustrates an example in which the speaker installation terminal 100 and the light-sound system control device 200 are connected via a network, this is merely for convenience of understanding, and the number of devices that can be connected to the network may vary.

Meanwhile, FIG. 1 merely illustrates a preferred embodiment for achieving the object of the present disclosure, and some components may be added or deleted as needed. Hereinafter, the components illustrated in FIG. 1 will be described in greater detail.

The light-sound system control device 200 may collect and analyze various types of information that is generated by the speaker installation terminal 100. Various types of information may include all data generated by the speaker installation terminal 100, and the light-sound system control device 200 may include a database. The database may include speaker installation position information, speaker specification information, movie theater information, and the like. Further, the database may store information on moviegoers watching a film, film screening information, size information of a movie theater in which the film is screened, basic information on the film that is screened at the movie theater, and the like.

The speaker installation terminal 100 illustrated in FIG. 1 may be implemented through at least one electronic device and at least one computing device, and the speaker installation terminal 100 may be connected to the light-sound system control device 200 of the present disclosure via the network and may transmit or receive data to or from the light-sound system control device 200. Accordingly, the speaker installation terminal 100 may be a computing device, a mobile device, a desktop, a laptop, or the like, or may be a high-performance server-level computing device. The speaker installation terminal 100 may be a terminal of a worker who performs speaker installation. Accordingly, the worker may check a speaker installation position or information on speaker installation through the speaker installation terminal 100.

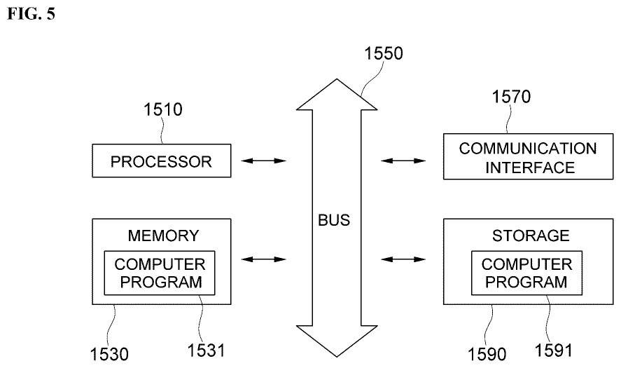

Meanwhile, the light-sound system control device 200 may also be implemented with one or more computing devices. For example, all functions of the light-sound system control device 200 may be implemented on a single computing device. As another example, a first function of the light-sound system control device 200 may be implemented on a first computing device, and a second function may be implemented on a second computing device. Here, the computing device may be a laptop or desktop computer, but is not limited thereto and may include any type of device with a computing function. However, the light-sound system control device 200 is preferably implemented by a high-performance, server-level computing device. An example of the computing device will be described with reference to FIG. 5.

Further, functions that may be implemented in the light-sound system control device 200 may also be implemented by utilizing an electronic device mounted on the speaker installation terminal 100. Thus, while FIG. 1 illustrates the light-sound system control device 200 and the speaker installation terminal 100 as separate entities, it is apparent that, in an embodiment, the light-sound system control device 200 may be mounted on the speaker installation terminal 100 to implement the first function, the second function, and the like within the speaker installation terminal 100. Therefore, it should be noted that the present disclosure is not limited to the embodiment in which the speaker installation terminal 100 and the light-sound system control device 200 are externally separated, as illustrated in FIG. 1.

For convenience of description, a situation in which the speaker installation terminal 100 and the light-sound system control device 200 are provided separately to implement functions will be described.

In some embodiments, components included in an environment in which the light-sound system control device 200 is applied may perform communication via a network. The network may be implemented as any type of wired/wireless network, such as a local area network (LAN), a wide area network (WAN), a mobile radio communication network, or a wireless broadband internet (Wibro).

Meanwhile, an environment illustrated in FIG. 1 shows that the speaker installation terminal 100 and the light-sound system control device 200 are connected via the network, but the scope of the present disclosure is not limited thereto and it should be noted that the speaker installation terminal 100 may also be connected to the light-sound system control device 200 in a peer-to-peer (P2P) manner.

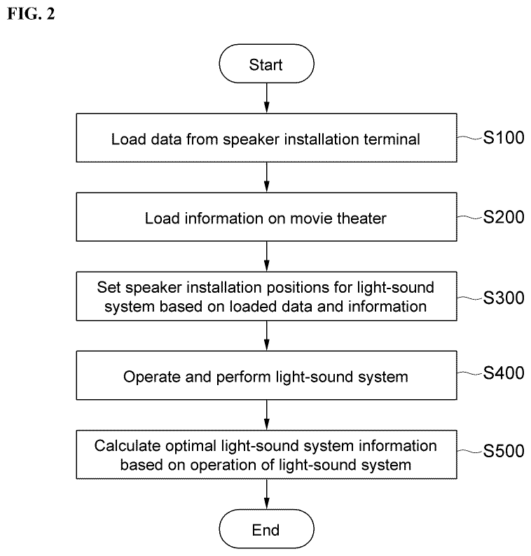

An exemplary environment in which the light-sound system control device 200 according to some embodiments of the present disclosure can be applied has been described with reference to FIG. 1. Hereinafter, methods according to various embodiments of the present disclosure will be described in detail with reference to FIG. 2 and subsequent drawings.

Respective steps of methods to be described below may be performed by the computing device. In other words, the respective steps of the methods may be implemented as one or more instructions that are executed by a processor of the computing device. All the steps included in these methods may be executed by a single physical computing device, but first steps of the methods may be performed by a first computing device and second steps of the methods may be performed by a second computing device.

Hereinafter, the description will proceed with reference to FIG. 2 on the assumption that respective steps of the methods are performed by the light-sound system control device 200 illustrated in FIG. 1. However, for convenience of description, description of entities that perform the respective steps of the methods may be omitted.

FIG. 2 is a flowchart of a light-sound system control operation that may be performed by the light-sound system control device according to some embodiments of the present disclosure.

In step S100, the light-sound system control device 200 may load data from the speaker installation terminal 100. In step S200, the light-sound system control device 200 may load information on a movie theater. In this case, the data loaded by the light-sound system control device 200 in steps S100 and S200 may include all data generated from the speaker installation terminal 100, and may include the information on moviegoers watching a film, the film screening information, the size information of the movie theater in which the film is screened, the basic information on the film that is screened at the movie theater, and the like.

Therefore, based on the loaded data, the light-sound system control device 200 may calculate, for example, specifications, positions, and basic information of the speakers to be installed in the movie theater.

In step S300, the light-sound system control device 200 may set speaker installation positions for the light-sound system based on the loaded data and information. The speakers described in the present disclosure may include at least six woofer speakers and two or more side/rear surround woofers as a basic specification, the woofer speakers are arranged forward to be exposed in front of a screen so that the woofer speakers are within a field of view of the audience, and the four central woofer speakers among the woofer speakers may receive LFE signals. Left and right woofer speakers may handle Low signals of front left and right speakers, respectively and may double an LFE signal.

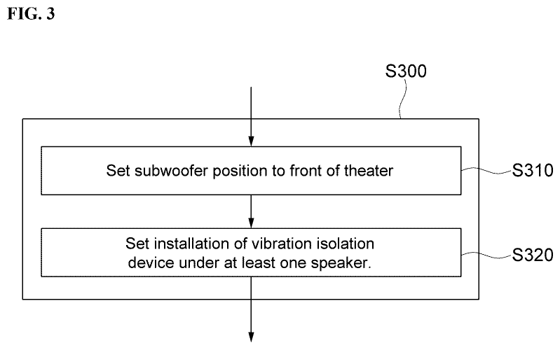

Hereinafter, a more specific example will be described with reference to FIG. 3.

FIG. 3 is a flowchart for specifically describing a step of setting speaker installation positions for the light-sound system according to some embodiments of the present disclosure.

In step S310, the light-sound system control device 200 may set a subwoofer position to the front of the movie theater. In step S320, the light-sound system control device 200 may set installation of a vibration isolation device under at least one speaker.

The woofer speaker may reduce loss and distortion caused by omnidirectional emission in a low frequency range through the vibration isolation device using aluminum spikes, marble (alabaster), and rubber pads at the bottom, and minimize noise.

The vibration isolation device may include four spikes, marble, and rubber pads installed at the bottom of the speaker, and the spikes may be constituted by a fixing member coupled to a speaker body, a spike body, and a spike shoe coupled to the marble. In this case, a thickness of the marble is set to 30 mm, a thickness of the rubber pad is set to 10 mm, and the vibration isolation device evenly disperses a vibration of the speaker generated due to the amplified sound pressure applied to the light-sound through spikes at respective corners and suppresses the vibration through the marble and the rubber pads. This allows the speakers to transmit their natural sound pressure toward the audience, thereby generating natural vibrations, or so-called light-sound effect. The vibration of the speaker suppressed by the marble and rubber pad is offset by the floor, preventing the light-sound effects from affecting other architectural facilities.

The surround woofers receive surround sound signals and supplement a low frequency range that is not provided by existing full-range speakers, all speakers in the light-sound system need to include lighting, which not only enhances aesthetics but also informs the audience of positions of the speakers before screening to allow the audience to recognize sources of sounds and enhance immersive experience when the audience watches a film. In this case, lighting may be turned off along with theater lights when the film begins in order to avoid disrupting watching experience, and may be configured with relay power control through automation equipment so that the lighting can be turned off automatically without the need for personnel.

To minimize the sound pressure attenuation in the low frequency range due to the forward exposure arrangement of the woofer speaker and an arrangement distance, the theater may be limited to small and medium-sized movie theaters with less than 150 seats, but this is merely an example and is not be construed as being limited thereto.

When a size of the theater increases, addition of a front subwoofer and a surround woofer may be considered, and separate acoustic tuning for a general theater may be created so that an infrastructure is not changed, in preparation for a possible degradation in the quality of the light-sound effect due to defective additional speakers.

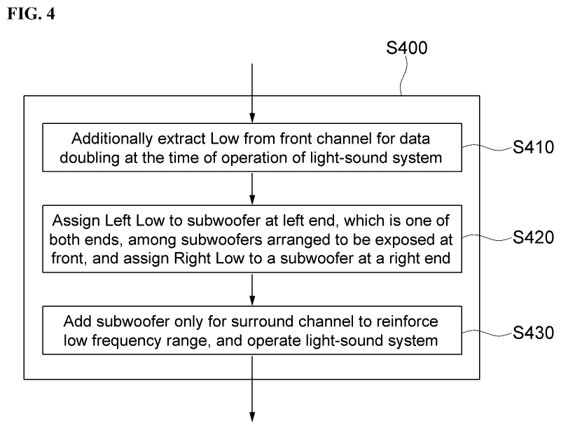

Referring back to FIG. 2, in step S400, the light-sound system control device 200 operates and performs the light-sound system. The light-sound system control device 200 may control the light-sound system so that the light-sound system operates according to film screening in the movie theater. Therefore, the process may be an operation performed simultaneously with the film being screened by an audience in the movie theater, or may be an operation for testing the operation of the light-sound system in the absence of an audience in the movie theater. Hereinafter, a case in which the light-sound system control device 200 is the operation for testing the operation of the light-sound system will be described in detail with reference to FIG. 4.

FIG. 4 is a flowchart for specifically describing a step of operating and performing the light-sound system according to some embodiments of the present disclosure.

Sound pressure of the light-sound system is set as amplified sound pressure compared to that according to an existing theater standard, but is adjusted within a X-curve to prevent distortion caused by excessive EQ. However, an entire frequency range is additionally partially modified, unlike an existing X-curve in which an average is set for each existing band.

An X-curve dedicated to light-sound is characterized by a max setting for an ultra-low frequency range (20 Hz to 200 Hz), and since a range from 200 Hz to 600 Hz generally classified as a low frequency band includes a male voice, the range is not greatly amplified to prevent distortion of the voice due to excessive amplification, and the range is evenly tuned to a mid-frequency range of 2 kHz.

A high frequency range (2 kHz and above) is set for cutting, converging on existing X-curve data at an amplification point to suppress affricates caused by amplification. For example, a low frequency range (20 to 200 Hz) is amplified by 3 dB or more compared to the existing X-curve, a mid-frequency band (200 to 2 kHz) is amplified by 1 to 2 dB compared to the existing X-curve, and a high frequency range (2 kHz to 20 kHz) is amplified by 3 dB and gradually converges on an average before being cut to 0 dB.

The speakers in the light-sound system include subwoofers and surround woofers which are arranged to be exposed at the front. Each subwoofer needs to have a specification capable of handling at least 600 to 800 W of output per unit, and may have a sensitivity of 94 dB or more and an instantaneous peak output of 120 dB or more. An amplifier with an output that is 1.5 times that of a speaker matched therewith may be selected.

With the addition of a large number of subwoofers in the light-sound system, it is possible to obtain unique sound effects and vibration effects due to sound pressure, that is, light-sound effects. The effects are not artificial vibration employed in a 4D system, but are natural vibration effects generated purely by sound pressure, which may amplify an immersive experience of watching a film.

An existing subwoofer is typically installed on a floor behind the screen, whereas in the present disclosure, the subwoofer is arranged in front, and as a device that maximizes the light-sound effects and stabilizes other architectural facilities without affecting the other architectural facilities, a vibration isolation device inspired by home cinema may be utilized. Since detailed description of the vibration isolation device has already been described above, the description will be omitted to avoid redundancy.

In step S410, the light-sound system control device 200 may additionally extract Low from a front channel for data doubling at the time of an operation of the light-sound system. In step S420, the light-sound system control device 200 may assign Left Low to a subwoofer at a left end, which is one of both ends, among subwoofers arranged to be exposed at the front, and assign Right Low to a subwoofer at a right end, which is the other end. In step S430, the light-sound system control device 200 may add a subwoofer only for a surround channel to reinforce a low frequency range and operate the light-sound system.

A light-sound cinema began with the reinforcement of a low frequency range to amplify only an LFE band, but since not all low frequency ranges of all films are transmitted in an LFE channel, and as measures for complementing this, Front Low may be additionally output through data doubling and surround bass speakers may be added. The data doubling is inspired by such approach, in which a signal from the same specific audio channel is simultaneously transmitted via speakers at different positions, creating an effect of multi-channel transmission even though such audio channel is a single channel, in other words, for Front Low added through such data doubling, when the light-sound effects are not generated due to the lack of LFE (subwoofer) transmission in a film itself, which is considered as an initial issue, Low may be additionally extracted from three front channels, including Left, Center, and Right inherent in all films, and be used for complementation so that the light-sound effects can also be generated in the films.

Front Low is also assigned to a front speaker by default, but this is hidden as a finished product behind a screen, and a technical specification of the light-sound system is not satisfied by the speaker alone, and thus, Left Low is assigned to a subwoofer at a left end among subwoofers arranged to be exposed at the front, and Right Low is assigned to a subwoofer at a right end.

For the data doubling, additional wirings are added to a Left Low signal and a Right Low signal generated by a sound processor and assigned to a separate amplifier, and this doubling allows the same data to be transmitted through the assigned subwoofer exposed at the front without damaging a Low signal generated by the existing front speakers.

The Surround Bass is a system in which a subwoofer dedicated to a surround channel is added to enhance a low frequency range that is difficult to achieve with a specification of typical surround speakers, and the speaker receives and transmits a surround channel signal as well. In other words, an existing full-range or two-way surround speaker includes a separate system capable of amplifying a low frequency range so that the speaker is substantially upgraded to a 3-way system and configured to achieve output equal to or greater than that of front speakers.

Referring back to FIG. 2, in step S500, the light-sound system control device 200 may calculate optimal light-sound system information based on an operation of the light-sound system.

The quantity and position of Left Low, Right Low, Extension LFE, Left Surround Bass, and Right Surround Bass for the operation of the light-sound system controlled by the light-sound system control device 200 may vary depending on a specification of the movie theater. Referring to Table 1, this is merely an example and should not be construed as being limited thereto.

TABLE 1

| | 150 seats or fewer | 150 seats or more |
|---|---|---|
| | (small/medium theater) | (medium/large theater) |
| Left Low | 1 or 2 | 2 or more |
| Right Low | 1 or 2 | 2 or more |
| Extension LFE | 3 or 4 | 3 to 6 or more |
| Left Surround Bass | 1 | 2 |
| Right Surround Bass | 1 | 2 |

Hereinafter, an exemplary computing device in which the light-sound system control device 200 can be implemented will be described in detail with reference to FIG. 5.

FIG. 5 is a diagram illustrating an exemplary computing device that can implement devices and/or systems according to various embodiments of the present disclosure.

A computing device 1500 may include one or more processors 1510, a bus 1550, a communication interface 1570, a memory 1530 into which a computer program 1591 executed by the processor 1510 is loaded, and a storage 1590 that stores the computer program 1591. However, only components related to the embodiment of the present disclosure are illustrated in FIG. 5. Therefore, it will be appreciated by those skilled in the art that other general-purpose components may be included in addition to the components illustrated in FIG. 5.

The processor 1510 controls an overall operation of each component of the computing device 1500. The processor 1510 may include a central processing unit (CPU), a microprocessor unit (MPU), a microcontroller unit (MCU), a graphic processing unit (GPU), or any type of processor well known in the art of the present disclosure. Further, the processor 1510 may perform operations for at least one application or program for executing the methods according to embodiments of the present disclosure. The computing device 1500 may include one or more processors.

The memory 1530 stores various types of data, commands, and/or information. One or more programs 1591 from the storage 1590 may be loaded into the memory 1530 to execute the methods according to the embodiments of the present disclosure. The memory 1530 may be implemented as a volatile memory such as a RAM, but the technical scope of the present disclosure is not limited thereto.

The bus 1550 provides a communication function between components of the computing device 1500. The bus 1550 may be implemented as any type of bus, such as an address bus, a data bus, and a control bus.

The communication interface 1570 supports wired and wireless Internet communication of the computing device 1500. Further, the communication interface 1570 may support various communication schemes other than the Internet communication. To this end, the communication interface 1570 may include a communication module well known in the technical field of the present disclosure.

According to some embodiments, the communication interface 1570 may be omitted.

The storage 1590 may non-temporarily store one or more programs 1591 and various types of data.

The storage 1590 may include a non-volatile memory such as a read only memory (ROM), an erasable programmable ROM (EPROM), an electrically erasable programmable ROM (EEPROM), or a flash memory, a hard disk, a detachable disk, or any other form of computer-readable recording medium well known in the technical field of the present disclosure.

The computer program 1591 may include one or more instructions that cause the processor 1510 to perform the methods/operations according to various embodiments of the present disclosure when loaded into the memory 1530. That is, the processor 1510 may perform the methods/operations according to various embodiments of the present disclosure by executing the one or more instructions.

Various embodiments of the present disclosure and the effects according to the embodiments have been described above with reference to FIGS. 1 to 5. The effects according to the technical spirit of the present disclosure are not limited to the effects described above, and other effects that are not mentioned will be clearly understood by those skilled in the art from the description of the disclosure.

The technical spirit of the present disclosure described above with reference to FIGS. 1 to 5 may be implemented by computer-readable code on a computer-readable medium. The computer-readable recording medium may be, for example, a portable recording medium (a CD, a DVD, a Blu-ray disc, a USB storage device, or a portable hard disk), or may be a fixed recording medium (a ROM, a RAM, or a hard disk for a computer). The computer program recorded on the computer-readable storage medium may be transmitted to another computing device via a network such as the Internet and installed on the other computing device, so that the computer program can be used on the other computing device.

Although all the components constituting the embodiments of the present disclosure have been described as being combined or operating in combination, the technical spirit of the present disclosure is not necessarily limited to such embodiments. That is, one or more of all the components may be selectively combined and operated without departing from the scope of the present disclosure.

Although the operations are illustrated in a specific order in the drawings, it should not be understood that the operations need to be performed in the illustrated specific order or in a sequential order, or that all illustrated operations need to be performed to obtain desired results. In specific situations, multitasking and parallel processing may be advantageous. In addition, the separation of various components in the embodiments described above should not be understood as being necessarily required, and it should be understood that the described program components and systems may generally be integrated into a single software product or packaged into multiple software products.

While the embodiments of the present disclosure have been described with reference to the accompanying drawings, it will be appreciated by those skilled in the art that the present disclosure may be implemented in other specific forms without departing from the technical spirit or essential features of the present disclosure. Therefore, the embodiments described above should be understood as illustrative in all respects and not restrictive. The scope of protection of the present disclosure should be construed according to the claims below, and all equivalents thereof should be construed as being included within the scope of the present disclosure defined by the present disclosure.

What is claimed is:

1. A method for installing and controlling light-sound cinema speakers to provide a light-sound system in a movie theater, which is performed by a light-sound system control device, the method comprising:
loading data from a speaker installation terminal;
loading information on the movie theater;
setting speaker installation positions for a light-sound system based on the loaded data and information;
operating and performing the light-sound system; and
calculating optimal information for the light-sound system based on the operation of the light-sound system.

2. The method of claim 1, wherein the setting of the speaker installation positions for the light-sound system based on the loaded data and information further includes setting a subwoofer position to the front of the movie theater.

3. The method of claim 2, wherein the setting of the speaker installation positions for the light-sound system based on the loaded data and information further includes setting installation of a vibration isolation device under at least one speaker.

4. The method of claim 1, wherein the operating and performing of the light-sound system further includes additionally extracting Low from a front channel for data doubling when the light-sound system operates.

5. The method of claim 4, wherein the operating and performing of the light-sound system further includes allocating Left Low to a subwoofer at a left end, which is one of both ends, among subwoofers arranged to be exposed at the front, and assigning Right Low to a subwoofer at a right end, which is the other end.

6. The method of claim 5, wherein the operating and performing of the light-sound system further includes adding a subwoofer only for a surround channel to reinforce a low frequency range, and operating the light-sound system.

7. A light-sound system control device for providing and controlling a light-sound system in a movie theater, the light-sound system control device comprising:
a processor;
a network interface;
a memory; and
a computer program loaded into the memory and executed by the processor,
wherein the processor is configured to execute
an instruction for loading data from a speaker installation terminal;
an instruction for loading information on the movie theater;
an instruction for setting speaker installation positions for a light-sound system based on the loaded data and information;
an instruction for operating and performing the light-sound system; and
an instruction for calculating optimal information for the light-sound system based on the operation of the light-sound system.

8. The light-sound system control device of claim 7, wherein the instruction for setting the speaker installation positions for a light-sound system based on the loaded data and information further includes an instruction for setting a subwoofer position to the front of the movie theater.

9. The light-sound system control device of claim 8, wherein the instruction for setting the speaker installation positions for a light-sound system based on the loaded data and information further includes an instruction for setting installation of a vibration isolation device under at least one speaker.

10. The light-sound system control device of claim 7, wherein the instruction for operating and performing the light-sound system further includes an instruction for additionally extracting Low from a front channel for data doubling when the light-sound system operates.

11. The light-sound system control device of claim 10, wherein the instruction for operating and performing the light-sound system further includes an instruction for allocating Left Low to a subwoofer at a left end, which is one of both ends, among subwoofers arranged to be exposed at the front, and assigning Right Low to a subwoofer at a right end, which is the other end.

12. The light-sound system control device of claim 11, wherein the instruction for operating and performing of the light-sound system further includes an instruction for operating the light-sound system by adding a subwoofer only for a surround channel to reinforce a low frequency range.
